(19) United States
(12) Patent Application Publication
(10) Pub. No.: US 2024/0106267 A1
(43) Pub. Date: Mar. 28, 2024

(54) POWER SUPPLY UNIT, POWER RECEIVING APPARATUS, AND POWER SUPPLY SYSTEM

(71) Applicant: CANON KABUSHIKI KAISHA, Tokyo (JP)

(72) Inventor: YUYA FUJIWARA, Kanagawa (JP)

(21) Appl. No.: 18/473,910

(22) Filed: Sep. 25, 2023

(30) Foreign Application Priority Data
Sep. 27, 2022 (JP) 2022-153466

(51) Int. Cl. H02J 13/00

(52) U.S. Cl. CPC H02J 13/00002

(57) ABSTRACT

In a case in which a power receiving apparatus is divided into a power supply unit and a main body unit, techniques and mechanisms are provided to enable a setting of an appropriate power classification according to the power supply capability of the power supply apparatus by configuring a power supply unit to enable power that the power supply unit requests from a power supply apparatus to be changed based on information received in a communication with the main body unit.

### BACKGROUND

### Field

The present disclosure relates to a power supply unit, a power receiving apparatus, and a power supply system.

### Description of the Related Art

In some power supply systems where power is supplied by separating the power supply apparatus and the power receiving apparatus, the power supply apparatus manages the power consumption of the power receiving apparatuses connected thereto so as to not exceed the supply capacity of the power of the power supply apparatus, in a case in which a plurality of power receiving apparatuses are connected to the power supply apparatus. As a typical example, a Power over Ethernet (PoE) (registered trademark) power supply defined in the IEEE 802.3af standard is known as a power supply for peripheral devices connected to a Local Area Network (LAN) cable.

PoE is a system that simultaneously performs data communication and power supply by Ethernet (registered trademark) wiring such as a LAN cable. In addition to IEEE 802.3af, PoE has other standardized specifications, such as IEEE 802.3at (PoE+) and IEEE 802.3bt (PoE++), as extension standards. In a PoE system, a power supply apparatus is referred to as a “power sourcing equipment” (PSE), and a power receiving apparatus is referred to as a “powered device” (PD), and the PSE manages the power consumption of a connected PD so as not to exceed a power supply capacity.

In a PoE power supply, when a PD receives power from a PSE, the following processes are performed between the PSE and the PD. First, as a detection, the PSE outputs a predetermined voltage to the PD and measures the resistance value of the classification resistor of the PD. Then, the PSE determines that the PD is present if the measured resistance value is within a predetermined range. Subsequently, the PSE performs a classification, and confirms the power classification (PoE classification) requested by the PD. Then, the PSE starts power supply to the PD in a case in which the PSE determines it is in a state in which it is capable of supplying the confirmed power. In this manner, the PSE assigns the classification-specific supplied power, which is set in steps corresponding to the classified power classification, to a power supply port, and supplies power to the PD.

In contrast, an image capturing apparatus in which the reliability of the image capturing apparatus is improved has been proposed. The image capturing apparatus is provided with an image capturing unit that acquires image information, a power source unit that supplies power to the image capturing unit, a power receiving coil that wirelessly receives power from a power supply unit and supplies the received power to the power source unit, and a housing that stores the power source unit and power receiving coil and holds the image capturing unit. The housing is removable from the power supply unit and is replaceable. Japanese Patent Laid-Open Publication No. 2020-144157 discloses a method of wirelessly supplying power from a power supply unit to a main body unit by using a power source unit and a power reception coil, and performing wireless data communication.

In the conventional technology disclosed in Japanese Patent Laid-Open Publication No. 2020-144157, consider, for example, as shown in FIG. 8, a seat portion in Japanese Patent No. 2020-144157 as a power supply unit and an electronic device main body as a main body unit, and the combined power supply unit, and main body unit as a PD. In Japanese Patent Laid-Open Publication No. 2020-144157, the power supply unit is not considered to manage power consumption by the PSE, a classification resistor is disposed in the power supply unit to manage the power consumption, and a determined power is requested from the PSE. Therefore, the power requested by the power supply unit to the PSE becomes the same value, regardless of the power consumption of the main body unit that is wirelessly connected. In contrast, when a case in which a classification resistor is present in a main body unit for managing power consumption is considered, it is possible to change the classification resistor by the power consumption of the main body unit. However, because the power supply unit and the main body unit are wirelessly connected, the PSE cannot detect the classification resistor of the main body unit.

### SUMMARY

Various embodiments of the present disclosure provide a power supply unit that enables an appropriate setting of an appropriate power classification according to the power supply capability of a power supply apparatus, even in a case in which the power receiving apparatus is divided into a power supply unit and a main body unit.

A power supply unit according to one embodiment of the present disclosure is a power supply unit configured to enable power that the power supply unit requests from a power supply apparatus to be changed based on information received in a communication with a main body unit, the power supply unit comprising a detection unit configured to detect a connection between the main body unit and the power supply unit, a power transmission unit configured to supply power to the main body unit, and a setting unit configured to set a power classification of the power that the power supply unit requests from the power supply apparatus, wherein the power transmission unit activates the main body unit by supplying power to the main body unit in a predetermined power classification in a case in which the detection unit has detected the connection between the main body unit and the power supply unit, and wherein the setting unit sets the power classification based on (i) a first power information, which is power information of the main body unit, and (ii) a second power information, which is power information of the power supply unit, and requests power in the set power classification from the power supply apparatus.

Further features of the present disclosure will become apparent from the following description of exemplary embodiments with reference to the attached drawings.

### BRIEF DESCRIPTION OF THE DRAWINGS

FIG. 1 is a block diagram of a PoE system in a First Embodiment.

FIG. 2 is a flowchart showing an example of a flow of an operation of a power supply unit in the First Embodiment.

FIG. 3 is a flowchart showing an example of a flow of an operation of a power supply unit in the First Embodiment.

FIG. 4 is a flowchart showing an example of a flow of an operation of a main body unit in the First Embodiment.

FIG. 5 is a flowchart showing an example a flow of an operation when the main body unit is disconnected from the power supply unit after power supply unit activation in the First Embodiment.

FIG. 6 is a diagram showing power classification and representative values of a classification resistor according to the IEEE 802.3at standard.

FIG. 7 is a diagram showing a circuit that performs switching of a classification resistor in the First Embodiment.

FIG. 8 is a block diagram showing a configuration example of a power supply unit that performs wireless power transmission and data communication, and a main body unit.

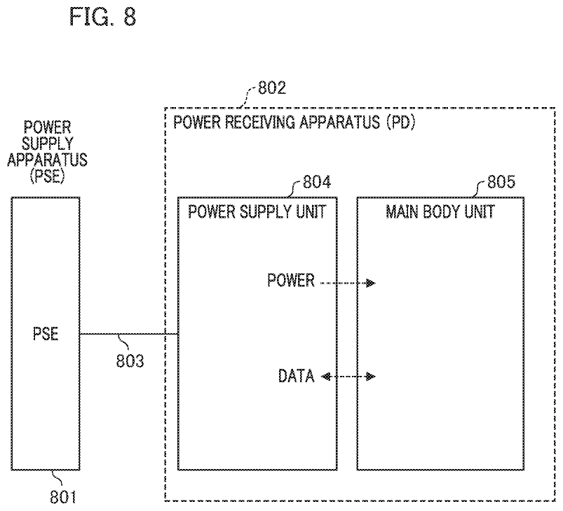

### DESCRIPTION OF THE EMBODIMENTS

Hereinafter, some embodiments of the present disclosure will be explained in detail with reference to the accompanying drawings. However, embodiments of the present disclosure are not limited to the embodiments described below. Further, please note that identical or equivalent components, members, and processing illustrated in the respective drawings are denoted by identical reference numerals, and duplicate descriptions are omitted as appropriate. In addition, in the drawings, some members which are not important for explanation are sometimes omitted.

### First Embodiment

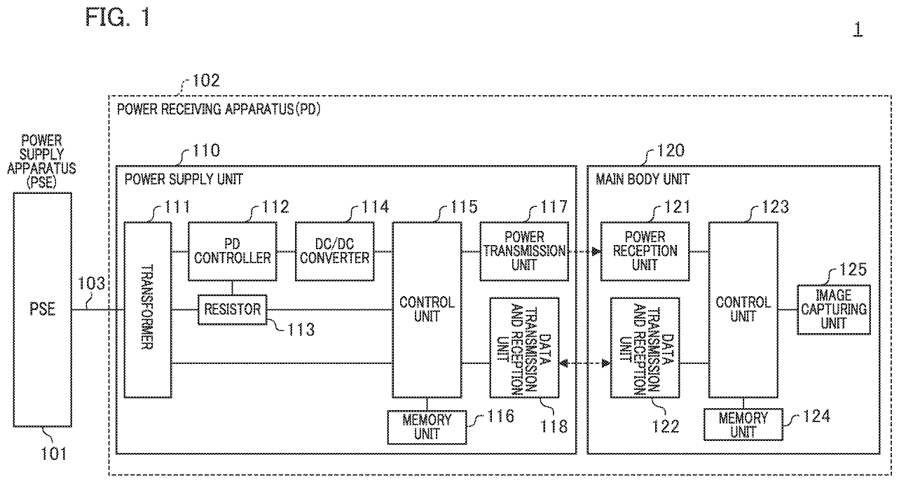

FIG. 1 is an example of a block diagram representing a configuration in a PoE system (power supply system) 1 of one embodiment of the present disclosure. The PoE system 1 in a First Embodiment is configured by a power sourcing equipment (PSE) 101 and a powered device (PD) 102. In addition, the PSE 101 and the PD 102 are each communicatively connected by a LAN cable 103.

The PSE 101 is a power supply apparatus that supplies power to the PD 102. The PD 102 is a power receiving apparatus that is configured by a power supply unit 110 and a main body unit 120. The power supply unit 110 and the main body unit 120 are each configured to be communicatively and detachably connected. It should be noted that in the present embodiment, the power supply unit 110 and the main body unit 120 perform wireless power transmission and data communication, but are not limited thereto, and for example, may be connected with the PSE 101 and with the PD 102 by a wired or a connector-based connection.

In the following, detailed blocks that configure the power supply unit 110 will be explained. The power supply unit 110 of the present embodiment is configured by a transformer 111, a PD controller 112, a resistor 113, a DC/DC converter 114, a control unit 115, a memory unit 116, a power transmission unit 117, and a data transmission and reception unit 118.

The transformer 111 separates the power supply and data. The PD controller 112 performs the process of detection and classification of the PSE 101.

The resistor 113 is a classification resistor which determines a PoE classification (power classification) for requesting power from the PSE 101, and can switch the resistance value by an instruction from the control unit 115. The relationship between the PoE classification and the resistance value of the classification resistor is discussed below.

The DC/DC converter 114 converts the voltage of the power that has been supplied from the PSE 101. The control unit 115 is a central processing unit (CPU) that integrally controls the operation of the power supply unit 110 and is configured by at least one computer. The control unit 115 performs control of the power supply unit 110 by executing a control program that has been stored in the memory unit 116 described below. The control unit 115 manages the supply of power to the main body unit 120, and transmits and receives data. In addition, the control unit 115 transmits control signals to the PD controller 112, the power transmission unit 117, and the data transmission and reception unit 118.

The memory unit 116 is a nonvolatile memory that does not volatilize even when the power supply is turned off, and stores control programs and other programs and data necessary for control. In addition, power consumption information (P_{BASE}), which is the maximum power consumption of the power supply unit 110, is stored (recorded) in the memory unit 116 in advance. The power transmission unit 117 transmits (supplies) power to the main body unit 120. The data transmission and reception unit 118 functions as a communication unit that transmits and receives data to and from the main body unit 120. The data transmission and reception unit 118 wirelessly communicates with the main body unit 120 in the First Embodiment.

It should be noted that in the First Embodiment, the power supply unit 110 is assumed to have one processor (control unit 115) that executes the processing of each unit in the power supply unit 110 by using at least one memory (memory unit 116). However, other configurations may be used. For example, a plurality of processors and a plurality of memories can execute the processing of each unit that configures the power supply unit 110 in cooperation with each other. Further, a part of the processing may be executed by a hardware circuit. A processor other than the CPU may be used to realize the functions and processing of the power supply unit 110 (for example, a graphics processing unit (GPU) can be used in place of the CPU).

In the following, detailed blocks that configure the main body unit 120 will be explained. The main body unit 120 of the First Embodiment is configured by a power reception unit 121, a data transmission and reception unit 122, a control unit 123, a memory unit 124, and an image capturing unit (imaging unit) 125.

The power receiving unit 121 receives power transmitted from the power transmission unit 117. The power receiving unit 121 of the First Embodiment functions as a power receiving unit that receives power. The data transmission and reception unit 122 transmits and receives data to and from the power supply unit 110. The data transmission and reception unit 122 wirelessly communicates with the power supply unit 110 in the First Embodiment. The control unit 123 is a central processing unit (CPU) that integrally controls the operation of the main body unit 120, and is configured by at least one computer. The control unit 123 performs control of the main body unit 120 by executing a control program that has been stored in the memory unit 124 described below. The control unit 123 transmits a control signal to the power receiving unit 121, the data transmission and reception unit 122, and the image capturing unit 125.

The memory unit 124 is a nonvolatile memory that does not volatilize even when the power supply is turned off, and stores control programs and other programs and data necessary for control. In addition, power consumption information (P_{MAIN}), which is the maximum power consumption of the main body unit 120, is stored in the memory unit 124 in advance.

The image capturing unit 125 is an image capturing apparatus configured by an image capturing portion that includes an image capturing lens and a solid-state image capturing element, such as a CCD or CMOS, and a signal processing unit and the like. The image capturing unit 125 delivers (transmits) image data obtained by capturing an image (imaging) the subject and converting the optical data into an electrical signal to the control unit 123.

It should be noted that in the First Embodiment, the main body unit 120 is assumed to have one processor (control unit 123) that executes the processing of each constituent unit in the main body unit 120 by using at least one memory (memory unit 124). However, other configurations may be used. For example, a plurality of processors and a plurality of memories can execute the processing of each unit that configures the main body unit 120 in cooperation with each other. Further, a part of the processing may be executed by a hardware circuit. A processor other than the CPU may be used to realize the functions and processing of the main body unit 120 (for example, a graphics processing unit (GPU) can be used in place of the CPU).

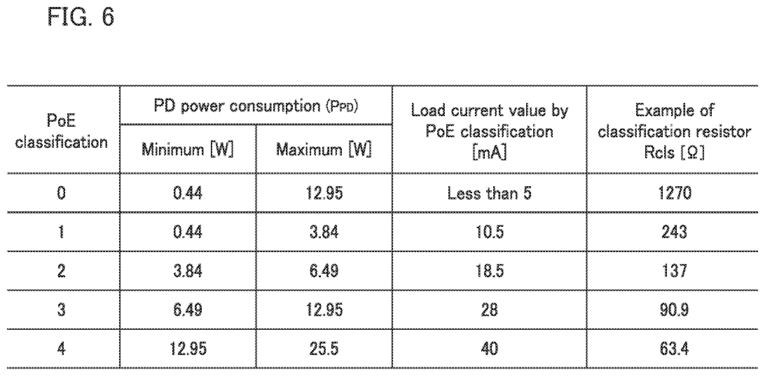

FIG. 6 is a diagram showing power classification and representative values of a classification resistor according to the IEEE 802.3at standard. Specifically, FIG. 6 is a diagram that shows combinations of the power consumption of the PD 102 corresponding to each power classification defined in the IEEE 802.3at standard, the load current value used by the PSE 101 to identify the PoE classification, and examples of the resistance value of the classification resistor used to determine the PoE classification. For example, in a case in which the PoE classification is set to be 2, the PoE classification can be set to be 2 by setting the resistance value of the classification resistor (Rcls) to 137 [Ω] or a value close to 137 [Ω].

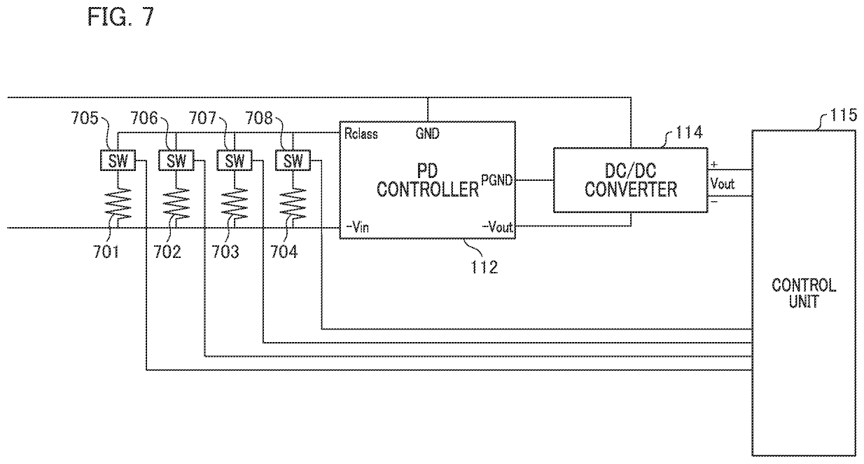

FIG. 7 shows a more detailed circuit of the PD controller 112, the resistor 113, the DC/DC converter 114, and the control unit 115 shown in FIG. 1. The circuit shown in FIG. 7 is a setting circuit for setting the PoE classification of power required by the PSE 101, and the circuit is configured by a PoE controller IC.

A resistor 701, a resistor 702, a resistor 703, and a resistor 704 in the circuit shown in FIG. 7 are classification resistors (Rcls). A component 705, a component 706, a component 707, and a component 708 are switches that can be switched on/off by a control signal from the control unit 115. These switches may be semiconductor switches, such as FETs or transistors, or switches such as mechanical relays. The component 705 can switch the resistor 701 on/off. The component 706 can switch the resistor 702 on/off. The component 707 can switch the resistor 703 on/off. The component 708 can switch the resistor 704 on/off. In the present embodiment, components 705 to 708 function as switching members for switching each of resistors 701 to 704 on/off. The PD controller 112 can perform the setting of the PoE classification of the PD 102 by inserting a classification resistor between Rclass and −Vin.

The DC/DC converter 114 is connected to the PD controller 112. The control unit 115 can switch each of components 705 to 708 by a control signal. By switching components 705 to 708 in this manner, it is possible to set a classification resistor for setting a PoE classification shown in FIG. 6 to an appropriate value.

In a case in which the PD controller 112 sets a resistor to an appropriate classification setting value in a state in which the PD controller is not powered by the PSE 101, the setting of a resistor to the appropriate classification setting value can be made possible by having a power source such as a battery or a large-capacity capacitor. It should be noted that in a case in which there is no power information of the main body unit 120 and a classification resistance value (resistance setting value) is not set, the classification resistor is set to operate in PoE classification 1, which is the smallest (lowest) classification of requested power that can be set by the PSE 101.

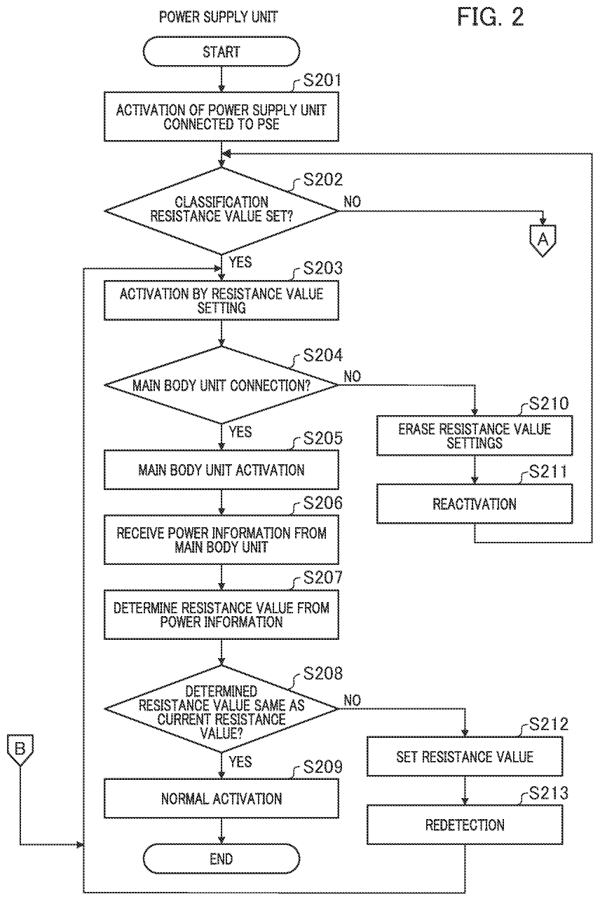

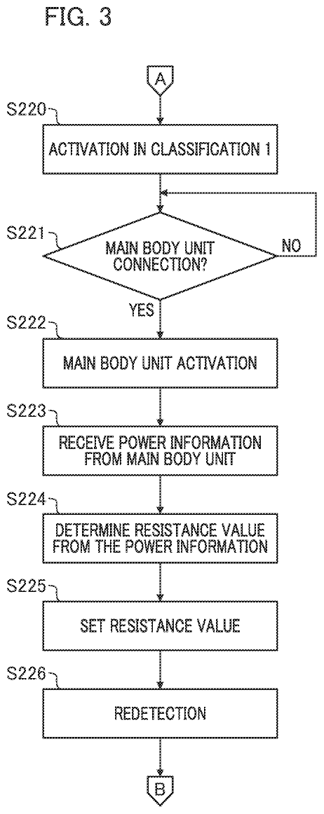

FIG. 2 and FIG. 3 are flowcharts showing the flow of the operation of the power supply unit 110 in the First Embodiment. Specifically, they are flowcharts that show the flow of operations in which the power supply unit 110 sets an appropriate PoE classification according to the power supply capability of the PSE 101 in a case in which the PD 102 is separated into the power supply unit 110 and the main body unit 120. Below, the flow of the operation of the power supply unit 102 in the First Embodiment will be explained with reference to the flowcharts of FIG. 2 and FIG. 3. In addition, in the following description, the notation of processes (steps) is omitted by mentioning each process (step) with S added to the beginning thereof.

First, in S201, the PSE 101 is connected to the PD 102. Specifically, the PD 102 is connected to the PSE 101 by using a LAN cable 103 or the like. By the PSE 101 being connected to the PD 102, the power supply unit 110 is activated.

Next, in S202, the control unit 115 reads the data of the memory unit 116 and performs a detection to detect whether or not there is a setting of a classification resistance value calculated from the power consumption of the PD 102. The process proceeds to S203 in a case in which a classification resistance value has been set. In contrast, the process proceeds to S220 in a case in which a classification resistance value has not been set according to the detection result. It should be noted that in the case of the initial state, because the classification resistance value is not set, in the following explanation, the explanation will start first with S220, which proceeds in a case in which there is no class resistance value set with reference to FIG. 3.

In S220 shown in FIG. 3, because the power supply unit 110 does not have data of the power consumption of the main body unit 120 (P_{MAIN}), the PD 102 is activated in a predetermined PoE classification. Specifically, after the classification resistance that operates in PoE classification 1 having the lowest requested power has been set, the PD 102 is activated in PoE classification 1.

Next, in S221, the presence or absence of a connection between the power supply unit 110 and the main body unit 120 is detected. As a result of the detection, in a case in which the main body unit 120 is not connected to the power supply unit 110, the power supply unit 110 waits until the main body unit 120 is connected thereto. In a case in which the main body unit 120 is connected to or has been connected to the power supply unit 110, the processing proceeds to S222. Whether or not the main body unit 120 has been connected to the power supply unit 110 may be confirmed by, for example, the control unit 115 detecting the presence or absence of the connection by detecting the current of the power transmission unit 117 or by detecting a change in the current. Alternatively, the presence or absence of a connection may be confirmed by detecting whether or not data has been received by the data transmission and reception unit 118. Furthermore, a connection detection switch that is physically switched by the connection of the main body unit 120 to the power supply unit 110 is disposed, and the on/off of the switch may be detected by the control unit 115 to confirm the presence or absence of the connection. During the present processing, the control unit 115 functions as a detection unit that detects the presence or absence of the connection of the main body unit 120.

Next, in S222, the power transmission unit 117 of the power supply unit 110 supplies (provides) a predetermined power to the main body unit 120. It should be noted that at S222, the power transmission unit 117 supplies power to the main body unit 120 in PoE classification 1 as the predetermined power. During the present processing, the power transmission unit 117 functions as a power supply unit (Power supply mechanism) that transmits (provides) power to the main body unit 120. The main body unit 120 is activated by the supply of the predetermined power to the main body unit 120. At this time, the main body unit 120 is activated in the activation preparation mode. Here, the activation preparation mode is a mode in which the main body unit 120 operates with a function necessary for communication with the power supply unit 110, and reduces the power consumption of the main body unit 120.

Next, in S223, the control unit 123 of the main body unit 120 transmits power consumption information (P_{MAIN}), which is power information of the main body unit 120 (first power information) that has been stored in the memory unit 124, to the power supply unit 110. Transmission of data (power consumption information) is performed via the data transmission and reception unit 122. The received power consumption information (P_{MAIN}) of the main body unit 120 is then stored in the memory unit 116. It should be noted that the control unit 115 of the power supply unit 110 may read the power consumption information (P_{MAIN}) of the main body unit 120 from the memory unit 123 of the main body unit 120, and acquire the power consumption information (P_{MAIN}) via the data transmission and reception unit 118.

Next, in S224, the control unit 115 reads the power consumption information of the main body unit 120 (P_{MAIN}) and the power consumption information (P_{BASE}), which is the power information of the power supply unit 110 (second power information), from the memory unit 116 and combines each together. Thereafter, the control unit 115 stores the added total power consumption information as the power consumption information (P_{PD}) of the PD 102 in the memory unit 116 of the power supply unit 110. It should be noted that when the power consumption information (P_{PD}) of the PD 102 is stored in the memory unit 116 of the power supply unit 110, the power consumption information (P_{PD}) of the PD 102 may also be stored in the memory unit 124 of the main body unit 120. During the present processing, the memory unit 116 or the memory unit 124 functions as a holding unit that holds (stores) the power consumption information (P_{PD}) of the PD 102.

Here, a formula for calculating the power consumption information (P_{PD}) of the PD 102 is shown in Formula 1 below.

(Formula 1)

P_{PD}=P_{BASE}+P_{MAIN} (1)

The control unit 115 determines a classification resistance value based on the table of FIG. 6 from the power consumption information (PPD) of the PD 102 calculated by the above-described Formula (1). Note that numerical information or a table, such as each numerical value or combination of each numerical value shown in the table in FIG. 6, is stored in, for example, the memory unit 116 of the power supply unit 110 or the like.

Next, in S225, the control unit 115 sets the classification resistance value by controlling the on/off of the switches of the component 705, the component 706, the component 707, and the component 708 (on/off setting) so that the classification resistance value becomes the classification resistance value determined by S224. The set classification resistance value is stored in the memory unit 116, for example, by the control unit 115. Thus, the PoE classification (power classification) can be set based on the calculated classification resistance value. During the present processing, the control unit 115 functions as a setting unit that sets the PoE classification of the power requested by the PSE 101.

Next, in S226, the power supply unit 110 executes a detection again (redetection) to detect whether the PD 102 is reactivated or whether or not there is a setting of a calculated classification resistance value calculated from the power consumption of the PD 102. The reactivation may be executed by the control unit 115 or the PD controller 112, or by cutting the circuit of the power supply supplied from a Position Sensitive Detector (PSD) by a switch, such as a relay, so as to reactivate the power supply. In the detection, as described above, the control unit 115 detects whether or not there is a setting of the classification resistance value calculated from the power consumption of the PD 102 by reading the data of the memory unit 116.

The process from S220 to S226 is a process of a case in which the classification resistance value is not set, and next, the processing of a case in which the classification resistance value is set is explained below with reference to FIG. 2.

Returning to FIG. 2, next, in S203, the control unit 115 requests power in the PoE classification based on the set classification resistance value to the PSE 101, and the PD 102 activates in the PoE classification based on the classification resistance value. It should be noted that when proceeding from S226 to S203 and in a case in which the PoE classification set by S225 is different from PoE classification 1, the power requested from the PSE 101 is changed based on the set classification resistance value of the PoE classification, and the PD 102 is activated in the set PoE classification.

Next, in S204, the presence or absence of a connection between the power supply unit 110 and the main body unit 120 is detected. As a result of the detection, in a case in which the main body unit 120 is not connected to the power supply unit 110, the processing proceeds to S210. In contrast, in a case in which the main body unit 120 is connected to or has been connected to the power supply unit 110, the processing proceeds to S205. During the present processing, the control unit 115 functions as a detection unit that detects the presence or absence of the connection of the main body unit 120. It should be noted that because the method of confirming whether or not the main body unit 120 has been connected to the power supply unit 110 is similar to the content explained by S221, a detailed explanation thereof is omitted.

Next, in S210, the control unit 115 erases the setting of the classification resistance value of the PD 102 stored in the memory unit 116, and returns the setting of the classification resistance value to an initial state. It should be noted that S210 is processing that proceeds in a case in which the classification resistance value has been set once, but the main body unit 120 has subsequently been removed, or the like.

Next, in S211, the power supply unit 110 reactivates the PD 102. Here, because the main body unit 120 is not connected to the power supply unit 110, the power supply unit 110 is reactivated. The reactivation may be executed by the control unit 115 or the PD controller 112, for example, by turning off the circuit of the power supply supplied from the PSD by a switch, such as a relay, to reactivate the power supply. After reactivation, the process returns to S202, and similar processing is repeated. It should be noted that in a case of proceeding from S211 to S202, because the setting of the classification resistance value is in an erased state, the process proceeds to S220 in a case in which there is no setting of the classification resistance value, and the setting of the classification resistance value is performed again.

Next, in S205, power supply unit 110 supplies (provides) a predetermined power to the main body unit 120 via the power transmission unit 117. At S205, the power transmission unit 117 supplies power to the main body unit 120 in the PoE classification based on the set classification resistance value as the predetermined power. During this processing, the power transmission unit 117 functions as a power transmission unit that transmits (provides) power to the main body unit 120. The main body unit 120 is activated by the supply of the predetermined power to the main body unit 120. At this time, the main body unit 120 is activated in the activation preparation mode.

Next, in S206, the control unit 123 of the main body unit 120 transmits power consumption information (P_{MAIN}), which is the power information of the main body unit 120 that has been stored in the memory unit 124, to the power supply unit 110. The transmission of data (power consumption information) is performed via the data transmission and reception unit 122. Thereafter, the received power consumption information (P_{MAIN}) of the main body unit 120 is stored in the memory unit 116. It should be noted that the control unit 115 of the power supply unit 110 may read the power consumption information (P_{MAIN}) of the main body unit 120 from the memory unit 123 of the main body unit 120 and acquire the power consumption information (P_{MAIN}) via the data transmission and reception unit 118.

Next, in S207, the control unit 115 reads the power consumption information (P_{MAIN}) of the main body unit 120 and the power consumption information (P_{BASE}) of the power supply unit 110 from the memory unit 116, and combines each together. Thereafter, the control unit 115 stores the added total power consumption information as the power consumption information (P_{PD}) of the PD 102 in the memory unit 116 of the power supply unit 110. It should be noted that when the power consumption information (P_{PD}) of the PD 102 is stored in the memory unit 116 of the power supply unit 110, the power consumption information (P_{PD}) of the PD 102 may also be stored in the memory unit 124 of the main body unit 120. Here, the power consumption information (P_{PD}) of the PD 102 is calculated by the above-described Formula (1) similar to S224, and a classification resistance value is determined from the table of FIG. 6. During the present processing, the memory unit 116 or the memory unit 124 functions as a holding unit that holds (stores) the power consumption information (P_{PD}) of the PD 102.

Next, in S208, the control unit 115 compares whether or not the classification resistance value determined in S207 is the same as the currently set (currently supplied) classification resistance value. As a result of the comparison, in a case in which the classification resistance value obtained in S207 is the same as the currently set classification resistance value, the process proceeds to S209. In contrast, in a case in which the classification resistance value obtained in S207 is different from the currently set classification resistance value, the process proceeds to S212. It should be noted that in S208, it is possible to compare whether the PoE classification is the same or not, rather than a classification resistance value. As a result of the comparison, in a case in which the power classification in the classification resistance value obtained in S207 is the same as the power classification in the currently set classification resistance, the process proceeds to S209. In contrast, in a case in which the power classification in the classification resistance value determined in S207 is different from the power classification in the currently set classification resistance value, the process proceeds to S212.

Next, in S212, the control unit 115 sets the classification resistance value by controlling the on/off of the switches of component 705, component 706, component 707, and component 708 (on/off setting) so that the classification resistance value becomes the classification resistance value determined by S207. The set classification resistance value is stored in the memory unit 116, for example, by the control unit 115. Thus, the power classification (PoE classification) can be set based on the calculated classification resistance value. During the present processing, the control unit 115 functions as a setting unit that sets the PoE classification of the power requested by the PSE 101. In a case in which the classification resistance values compared in S208 are different, the power consumption of the main body unit 120 detected after the activation of the power supply unit 110 differs from the power consumption of the main body unit 120 set by the power supply unit 110 during the previous activation. Therefore, a state in which the main body unit 120 has been changed between the last activation and the current activation is shown.

Next, in S213, the power supply unit 110 executes a detection again (redetection) to detect whether the PD 102 is reactivated or whether or not there is a setting of a calculated classification resistance value calculated from the power consumption of the PD 102. Then, the process is returned to S203, and similar processing as described above is repeated. It should be noted that in a case in which the processing proceeds from S213 to S203, because the classification resistance value set in S203 is in a state in which it is different from the classification resistance value obtained in S207, the power requested from the PSE 101 is changed based on the classification resistance value of the PoE classification reset in S212 after resetting. Then, similarly, the PD 102 is activated in the set PoE classification.

Next, in S209, normal activation of the main body unit 120 is performed, and the flow is terminated.

According to the operation flow shown in FIG. 2 and FIG. 3, it is possible to provide a power supply unit that enables an appropriate setting of the PoE classification according to the power supply capability of the PSE 101, even in a case in which the PD 102 is divided into a power supply unit 110 and a main body unit 120. Furthermore, by the operation of the power supply unit 110, it is possible to set an appropriate PoE classification as the PD 102, even in a case in which the main body unit 120 has been removed from the power supply unit 110 while the power supply unit 110 is in operation.

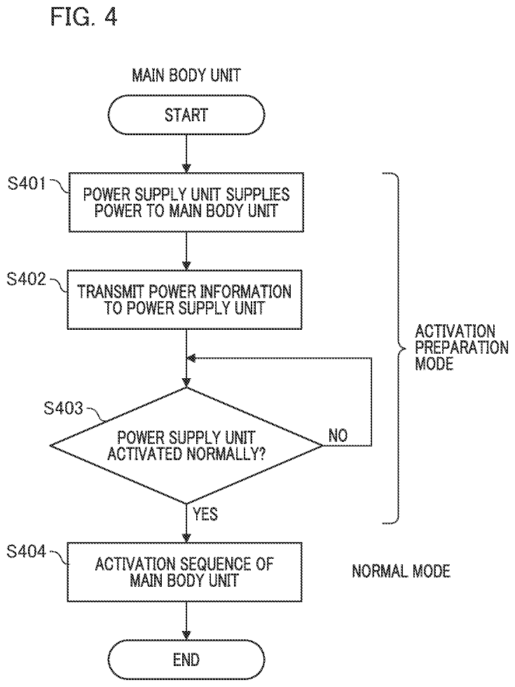

FIG. 4 is a flowchart showing the flow of the operation of the main body unit 120 in the present embodiment. Below, the flow of the operation of the main body unit 120 in the present embodiment is explained with reference to the flowchart of FIG. 4. In addition, in the following description, the notation of processes (steps) is omitted by mentioning each process (step) with S added to the beginning thereof.

First, in S401, the main body unit 120 is connected to the power supply unit 110. Thus, power is supplied to the main body unit 120 and the main body unit 120 is activated.

Next, in S402, the control unit 123 of the main body unit 120 transmits power consumption information (P_{MAIN}), which is power information of the main body unit 120 that has been stored in the memory unit 124, to the power supply unit 110. Transmission of data (power consumption information) is performed via the data transmission and reception unit 122. The received power consumption information (P_{MAIN}) of the main body unit 120 is then stored in the memory unit 116. It should be noted that the control unit 115 of the power supply unit 110 may read the power consumption information (P_{MAIN}) of the main body unit 120 from the memory unit 123 of the main body unit 120 and acquire the power consumption information (P_{MAIN}) via the data transmission and reception unit 118.

Next, in S403, it is determined as to whether or not the power supply unit 110 is normally activated. As a result of the determination, in a case in which the power supply unit 110 is not normally activated, the processing waits until the power supply unit 110 is normally activated. In contrast, in a case in which the power supply unit 110 is normally activated, the processing proceeds to S404. Here, the method of confirming that the power supply unit 110 is normally activated may be, for example, when communication between the control unit 123 and the data transmission and reception 118 or data transmission and reception 122 is detected, or by switching after a fixed period of time has elapsed. The fixed period of time is a time longer than the time from when the power supply unit 110 receives the power consumption information (P_{MAIN}) of the main body unit 120 (S206 and S223) to when redetection is performed (S213 and S226).

Next, in S404, the control unit 123 operates the image capturing unit 125, and transitions the camera function in the image capturing unit 125 to a normal mode (image capturing mode) in which the camera function is available.

According to the operation flow shown in FIG. 4, by operating the main body unit 120, it is possible for the main body unit 120 to always operate in the same sequence regardless of the state of the power supply unit 110.

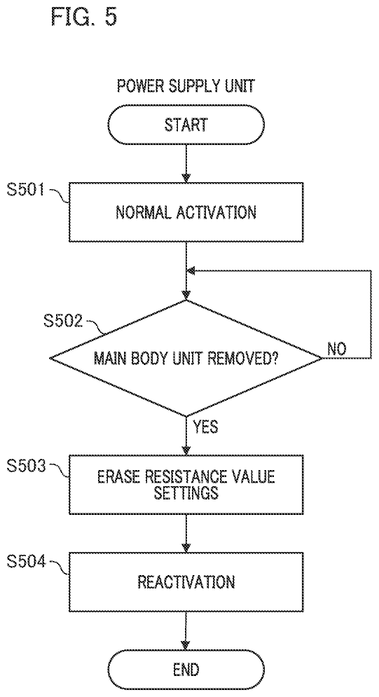

FIG. 5 is a flowchart showing the flow of an operation when the main body unit 120 is disconnected from the power supply unit 110 after activation in the present embodiment. In addition, in the following description, the notation of processes (steps) is omitted by mentioning each process (step) with S added to the beginning thereof.

First, in S501, the power supply unit 110 is activated normally. Similar to S201, the power supply unit 110 is activated by connecting the PSE 101 to the PD 102.

Next, in S502, it is determined whether or not the main body unit 120 has been removed during normal activation of the power supply unit 110. As a result of the determination, the power supply unit 110 waits until the main body unit 120 is removed in a case in which the main body unit 120 has not been removed during normal activation of the power supply unit 110. In contrast, in a case in which the main body unit 120 is removed during normal activation of the power supply unit 110, the processing proceeds to S503. It should be noted that it can be determined whether the main body unit 120 has been removed during normal activation of the power supply unit 110, for example, by the control unit 115 based on the power supply status from the power transmission unit 117 to the main body unit 120. In addition, in a case in which data communication with the main body unit 120 has become impossible at the data transmission and reception unit 118, it may be determined that the main body unit 120 has been removed. Furthermore, a connection detection switch that is physically switched by the connection of the main body unit 120 to the power supply unit 110 may be disposed, and the on/off of the switch may be detected by the control unit 115 to confirm whether or not the main body unit 120 has been removed.

Next, in S503, the control unit 115 erases the setting of the classification resistance value of the PD 102 stored in the memory unit 116, and returns the setting of the classification resistance value to an initial state. It should be noted that the processing of S503 is similar to that of S210, and a detailed description thereof is thus omitted.

Next, in S504, the power supply unit 110 reactivates the PD 102. It should be noted that the processing of reactivation in S504 is similar to that of S211, and a detailed description thereof is thus omitted.

In FIG. 2 and FIG. 3, the operation of the power supply unit 110 was explained with respect to the flow of setting the classification resistance value for the PoE classification setting, in a case in which the main body unit 120 has been removed from the power supply unit 110 during the operation of the power supply unit 110. In FIG. 4, the operation of the main body unit 120, independent of the operation of the power supply unit 110, was explained. In FIG. 5, the operation when the main body unit 120 is removed from the power supply unit 110 after activation was explained.

According to the PoE system 1 that includes the PD 102 of the present embodiment, the power supply unit 110 can set the resistance value of the appropriate classification resistance based on the consumed power consumption information of the main body unit 120 of the PD 102 and the power supply unit 110. In addition, according to the PoE system 1 that includes the PD 102 of the present embodiment, the PoE classification of the PD 102 can be appropriately set, and the power requested from the PSE 101 can be changed, even if the PD 102 is separated into a power supply unit 110 and a main body unit 120. Thus, it becomes possible to connect an appropriate number of PDs according to the power supply capability of the PSE 101.

While some embodiments of the present disclosure have been explained with reference to exemplary embodiments, it is to be understood that the disclosure is not limited to the disclosed example embodiments, and various changes and modifications are possible within the gist of the scope.

Various embodiment(s) of the present disclosure can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While example embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-153466, Sep. 27, 2022, which is hereby incorporated by reference wherein in its entirety.

What is claimed is:

1. A power supply unit configured to enable power that the power supply unit requests from a power supply apparatus to be changed based on information received in a communication with a main body unit, the power supply unit comprising:
a power transmission unit configured to supply power to the main body unit; and
at least one processor or circuit configured to function as:
a detection unit configured to detect a connection between the main body unit and the power supply unit, and
a setting unit configured to set a power classification of the power that the power supply unit requests from the power supply apparatus,
wherein the power transmission unit activates the main body unit by supplying power to the main body unit in a predetermined power classification in a case in which the detection unit has detected the connection between the main body unit and the power supply unit, and
wherein the setting unit sets the power classification based on (i) a first power information, which is power information of the main body unit, and (ii) a second power information, which is power information of the power supply unit, and requests power in the set power classification from the power supply apparatus.

2. The power supply unit according to claim 1, wherein the setting unit is further configured to change the power that the power supply unit requests from the power supply apparatus based on the power classification set by the setting unit, in a case in which the power classification set by the setting unit is different from the power classification of the power that is currently being supplied.

3. The power supply unit according to claim 1, wherein the power transmission unit is further configured to wirelessly supply power to the main body unit.

4. The power supply unit according to claim 1, wherein the setting unit is further configured to acquire the first power information from the main body unit via a communication unit configured to perform communication with the main body unit.

5. The power supply unit according to claim 4, wherein the communication unit is configured to perform wireless communication with the main body unit.

6. The power supply unit according to claim 1, further comprising a setting circuit configured to include a plurality of resistors, wherein the setting unit sets the power classification used for power supply to the main body unit and the power supply unit by the resistance value of the resistors in the setting circuit.

7. The power supply unit according to claim 6, comprising a switching member capable of switching on/off each of the plurality of resistors.

8. The power supply unit according to claim 7, wherein the setting unit is configured to determine a predetermined resistance value from the first power information and the second power information, and sets the power classification by switching the plurality of resistors on/off by using the switching member so as to become the predetermined resistance value.

9. The power supply unit according to claim 8, comprising a holding unit configured to hold a power classification of a switched state of the resistors even in a state in which power is not supplied from the power supply apparatus.

10. The power supply unit according to claim 1, wherein the detection unit is further configured to detect a connection between the power supply unit and the main body unit by at least one of a change in the electric current supplied to the main body unit, a data communication with the main body unit, or an on/off of a switch configured to switch in a state in which the main body unit is connected.

11. The power supply unit according to claim 1, wherein the predetermined power classification is the smallest classification among the requested power that can be set by the power supply apparatus.

12. The power supply unit according to claim 1, wherein the setting unit causes the main body unit to activate normally in a case in which the power classification set by the setting unit is the same classification as the power classification of the power that is currently being supplied.

13. The power supply unit according to claim 1, wherein the setting unit resets the power classification in a case in which the power classification set by the setting unit is a different classification from the power classification of the power that is currently being supplied.

14. The power supply unit according to claim 13, wherein the setting unit is configured to change the power that the power supply unit requests from the power supply apparatus based on the power classification after the reset.

15. The power supply unit according to claim 1, wherein the setting unit is further configured to erase information of the currently set power classification in a case in which the main body unit is not connected, and cause the power supply unit to reactivate.

16. The power supply unit according to claim 1, wherein the main body unit and the power supply unit are configured to be detachable.

17. A power receiving apparatus configured to enable power that a power supply unit requests from a power supply apparatus to be changed based on information received in a communication with a main body unit, wherein the power receiving apparatus is configured by the main body unit, and the power supply unit is communicatively connected to the main body unit,
wherein the main body unit comprises:
an image capturing unit configured to include image capturing element; and
at least one processor or circuit configured to function as:
a power receiving unit configured to receive power, and
wherein the power supply unit comprises:
a power transmission unit configured to supply power to the main body unit, and
at least one processor or circuit configured to function as:
a detection unit configured to detect a connection between the main body unit and the power supply unit, and
a setting unit configured to set a power classification of power that the power supply unit requests from the power supply unit,
wherein the power transmission unit activates the main body unit by supplying power to the main body unit in a predetermined power classification in a case in which a connection with the main body unit has been detected, and
wherein the setting unit sets of the power classification based on (i) a first power information, which is power information of the main body unit, and (ii) a second power information, which is power information of the power supply unit, and requests power in the set power classification from the power supply apparatus.

18. A power supply system,
the power supply system configured by a power receiving apparatus, and a power supply apparatus communicatively connected to the power receiving apparatus,
wherein the power receiving apparatus comprises a main body unit, and a power supply unit, the power supply unit communicatively connected to the main body unit,
wherein the main body unit comprises:
an image capturing unit configured to include image capturing element, and
at least one processor or circuit configured to function as:
a power receiving unit configured to receive power,
wherein the power supply unit comprises:
a power transmission unit configured to supply power to the main body unit; and
at least one processor or circuit configured to function as:
a detection unit configured to detect a connection between the main body unit and the power supply unit, and
a setting unit configured to set a power classification of power that the power supply unit requests from the power supply apparatus,
wherein the power transmission unit activates the main body unit by supplying power to the main body unit in a predetermined power classification in a case in which the detection unit has detected the connection between the main body unit and the power supply unit, and
wherein the setting unit sets the power classification based on (i) a first power information, which is power information of the main body unit, and (ii) a second power information, which is power information of the power supply unit, and requests power in the set power classification from the power supply apparatus, and
wherein the power supplying apparatus supplies power requested by the setting unit to the power receiving apparatus.
